(19) United States
(12) Patent Application Publication
(10) Pub. No.: US 2026/0334722 A1
(43) Pub. Date: Oct. 29, 2026

(54) OPENABLE KITCHEN APPLIANCE LID

(71) Applicant: Hamilton Beach Brands, Inc., Glen Allen, VA (US)

(72) Inventors: Suzanne Hensley, Glen Allen, VA (US); Derek McCullough, Glen Allen, VA (US); Paula Pennington, Glen Allen, VA (US)

(73) Assignee: Hamilton Beach Brands, Inc., Glen Allen, VA (US)

(21) Appl. No.: 19/193,172

(22) Filed: Apr. 29, 2025

(51) Int. Cl. A47J 36/12

(52) U.S. Cl. CPC A47J 36/12

(57) ABSTRACT

A kitchen appliance lid includes: a bridge; a first side section pivotally connected to the bridge; and a second side section pivotally connected to the bridge. The lid can move between: (i) a closed position, where the lower surfaces of the first side section, the bridge, and the second side section engage the rim of a kitchen appliance, covering most of the opening; (ii) a half-open position, where the first side section is perpendicular to the rim, and the lower surfaces of the bridge and second side section engage the rim; and (iii) a fully-open position, where the first side section is above the second side section, the lower surface of the second side section engages the rim, and the lower surface of the bridge is not engaged with the rim.

### FIELD OF THE INVENTION

The present disclosure generally relates to a lid for kitchen appliances that opens to permit access to the contents of the kitchen appliance without requiring the removal of the lid from the kitchen appliance.

### BACKGROUND

Many kitchen appliances have been developed which aid in the cooking and preparation of food products. These kitchen appliances may include or take the form of an at least partially hollow compartment. Some kitchen appliances utilize lids for a variety of reasons such as limiting or preventing moisture from escaping the confines of the appliance, limiting heat transfer between the appliance's contents and the external air, and/or limiting spillage or splashing of the appliance's contents. These lids may have features such as handles, vents, seals, dials, gauges, etc. which allow the lids to better fulfill their various intended purposes.

Some kitchen appliances may generate heat through internal electric heating elements while some other kitchen appliances have heat applied to them by external sources such as a stove top. In such instances, some of the kitchen appliance's contents may become water vapor which may condensate onto the internal or bottom surface of the lid. When the lid is removed the condensation may run out onto a countertop, table, or floor. In addition to this causing a mess, this may also cause the contents of the kitchen appliance to dry out more than would be preferred by a user.

It is often undesirable to set a kitchen appliance lid down on a surface other than the kitchen appliance itself. In addition to condensation, a kitchen appliance lid may have food products on it. Setting the kitchen appliance lid down may cause these contents to transfer to whatever surface it is placed on, making more of a mess that will need to be cleaned later. Contaminates from the surface the lid is placed on may also transfer to the lid and, if the lid is then placed back on the kitchen appliance, the contaminates may then be transferred to the kitchen appliance's contents. To avoid setting the lid down, a user may hold the lid in their hand while serving or stirring with their other hand. This is undesirable because it limits the user's ability to perform other tasks until they can place the lid back on the kitchen appliance.

Although conventional kitchen appliance lids may be adequate for many purposes, there may be instances in which a user would prefer to access the contents of a kitchen appliance without removing the lid. As such, it may be desirable to provide a kitchen appliance lid which opens to permit users to access the contents of the kitchen appliance.

### SUMMARY

As a first aspect, embodiments of the invention are directed to, a kitchen appliance lid including: a bridge; a first side section pivotally connected relative to the bridge; and a second side section pivotally connected relative to the bridge; the lid being moveable between: (i) a closed position, wherein a lower surface of the first side section, a lower surface of the bridge, and a lower surface of the second side section are engaged with a rim of a kitchen appliance and the lid covers substantially all of an opening of a cavity of the kitchen appliance; (ii) a half-open position, wherein the first side section is generally perpendicular to a plane of the rim of the kitchen appliance and the lower surface of the bridge and the lower surface of the second side section are engaged with the rim of the kitchen appliance; and (iii) a fully-open position, wherein the first side section is at least partially directly above the second side section, the lower surface of the second side section is engaged with the rim of the kitchen appliance, and the lower surface of the bridge is not engaged with the rim of the kitchen appliance.

As a second aspect, embodiments of the invention are directed to, a kitchen appliance including: a main body; a cavity, within the main body, having an opening; a rim including a perimeter of the cavity; and a lid configured to engage the rim of the kitchen appliance, the lid further including: a bridge; a first side section pivotally connected relative to the bridge; and a second side section pivotally connected relative to the bridge; the first side section being moveable between: (i) a closed position, wherein a lower surface of the first side section, a lower surface of the bridge, and a lower surface of the second side section are engaged with the rim of the kitchen appliance and the lid covers substantially all of the opening of the cavity of the kitchen appliance; (ii) a half-open position, wherein the first side section is generally perpendicular to the second side section and the lower surface of the bridge and the lower surface of the second side section are engaged with the rim of the kitchen appliance; and (iii) a fully-open position, wherein the first side section is at least partially directly above the second side section, the lower surface of the second side section is engaged with the rim of the kitchen appliance, and the lower surface of the bridge is not engaged with the rim of the kitchen appliance.

As a third aspect, embodiments of the invention are directed to, a kitchen appliance lid including: a bridge; a first side section pivotally connected relative to the bridge; and a second side section pivotally connected relative to the bridge; the lid being moveable between: (i) a closed position, wherein a lower surface of the bridge, a lower surface of the first side section, and a lower surface of the second side section are substantially planar and define a plane; (ii) a half-open position, wherein the lower surface of first side section is generally perpendicular to the plane; and (iii) a fully-open position, wherein the lower surface of the first side section is generally parallel to the plane and the lower surface of the bridge is generally perpendicular to the plane.

### BRIEF DESCRIPTION OF THE FIGURES

FIG. 1 is a schematic top view of an openable kitchen appliance lid according to some embodiments of the invention.

FIG. 2 is a schematic perspective view of the openable kitchen appliance lid of FIG. 1 and an exemplary kitchen appliance, with the lid in a closed position.

FIG. 3 is a schematic perspective view of the openable kitchen appliance lid and kitchen appliance of FIG. 2 with the lid in a first half-open position.

FIG. 4 is a schematic perspective view of a side section of the openable kitchen appliance lid of FIG. 1 with a cover.

FIG. 5 is a schematic perspective view of a side section of the openable kitchen appliance lid of FIG. 1 without a cover.

FIG. 6 is a schematic perspective view of the bridge and a side section of the openable kitchen appliance lid of FIG. 1 with a cover.

FIG. 7 is a schematic front view of the openable kitchen appliance lid and kitchen appliance of FIG. 2 with the lid in a closed position.

FIG. 8 is a schematic front view of the openable kitchen appliance lid and kitchen appliance of FIG. 2 with the lid in a half-open position.

FIG. 9 is a schematic front view of the openable kitchen appliance lid and kitchen appliance of FIG. 2 with the lid in a first fully-open position.

FIG. 10 is a schematic front view of the openable kitchen appliance lid and kitchen appliance of FIG. 2 with the lid in a second fully-open position.

FIG. 11 is a schematic side view of a hook of the openable kitchen appliance lid of FIG. 1.

FIG. 12 is a schematic top view of a hook of the openable kitchen appliance lid of FIG. 1.

FIG. 13 is a schematic perspective view of a hook of the openable kitchen appliance lid of FIG. 1.

### DETAILED DESCRIPTION

The present invention now is described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout and different embodiments of like elements can be designated using a different number of superscript indicator apostrophes (e.g., 10′, 10″, 10′″) or using different letters in conjunction with the same base reference number (e.g., 10a, 10b, 10c).

In the figures, certain layers, components or features may be exaggerated for clarity, and broken lines illustrate optional features or operations unless specified otherwise. This invention may, however, be embodied in many different forms and should not be construed as limited to the embodiments set forth herein; rather, these embodiments are provided so that this disclosure will be thorough and complete, and will fully convey the scope of the invention to those skilled in the art.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed as a second element, component, region, layer or section without departing from the teachings of the present invention. The sequence of operations (or steps) is not limited to the order presented in the claims or figures unless specifically indicated otherwise.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

As used herein, phrases such as “between X and Y” and “between about X and Y” should be interpreted to include X and Y. As used herein, phrases such as “between about X and Y” mean “between about X and about Y.” As used herein, phrases such as “from about X to Y” mean “from about X to about Y.”

Unless otherwise defined, as used herein, the terms “semi-circular”, “semi-circle”, and “half-circle” should be interpreted to include semi-oval and other oblong shapes.

As used herein, phrases such as “substantially parallel” and “generally parallel”, in addition to referring to perfectly parallel planes or lines, should be interpreted to include planes and lines which are not perfectly parallel. While no exact value range should be applied, planes and lines which are within 15 degrees of being parallel to another plane or line should be interpreted as being “generally” or “substantially” parallel. Similarly, phrases such as “substantially perpendicular” and “generally perpendicular”, in addition to referring to perfectly perpendicular planes or lines, should be interpreted to include planes and lines which are not perfectly perpendicular. While no exact value range should be applied, planes and lines which are within 15 degrees of being perpendicular to another plane or line should be interpreted as being “generally” or “substantially” perpendicular.

It is noted that aspects of the invention described with respect to one embodiment, may be incorporated in a different embodiment although not specifically described relative thereto. That is, all embodiments and/or features of any embodiment can be combined in any way and/or combination. Objects and/or aspects of the present invention are explained in detail in the specification set forth below. Further features, advantages and details of the present invention will be appreciated by those of ordinary skill in the art from a reading of the figures and the detailed description of the preferred embodiments that follow, such description being merely illustrative of the present invention.

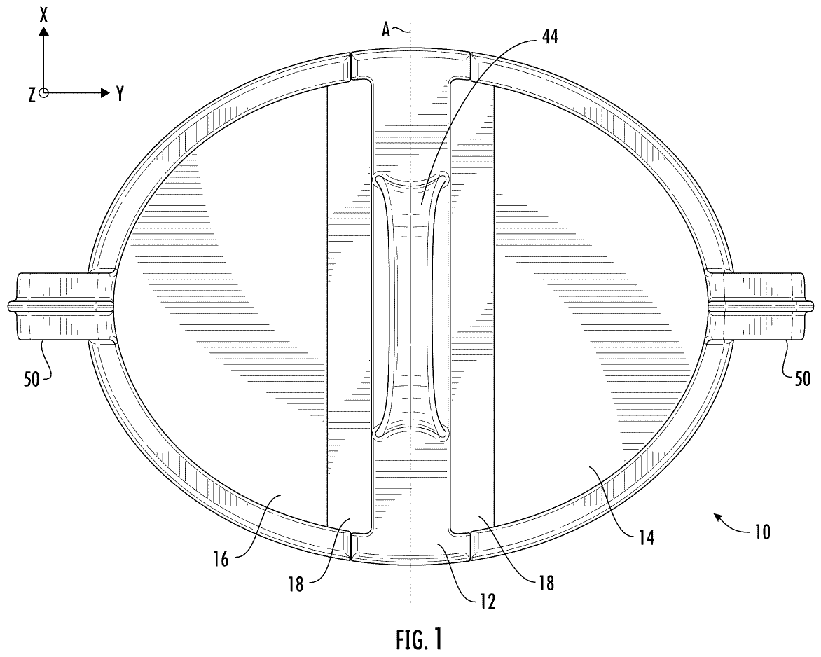

Referring now to the figures, FIGS. 1-3 illustrate a lid 10 according to some embodiments of the invention. Unless otherwise stated, all descriptions herein refer to the positions of the components when the lid 10 is in a closed position 60. In some embodiments, the lid 10 is used in conjunction with a kitchen appliance 20. The lid 10 may be configured to be attached to the kitchen appliance 20 or it may be configured to be completely removable from the kitchen appliance 20. Kitchen appliance 20 is illustrated as a slow cooker; however, the kitchen appliance 20 may also be any of a number of other kitchen appliances.

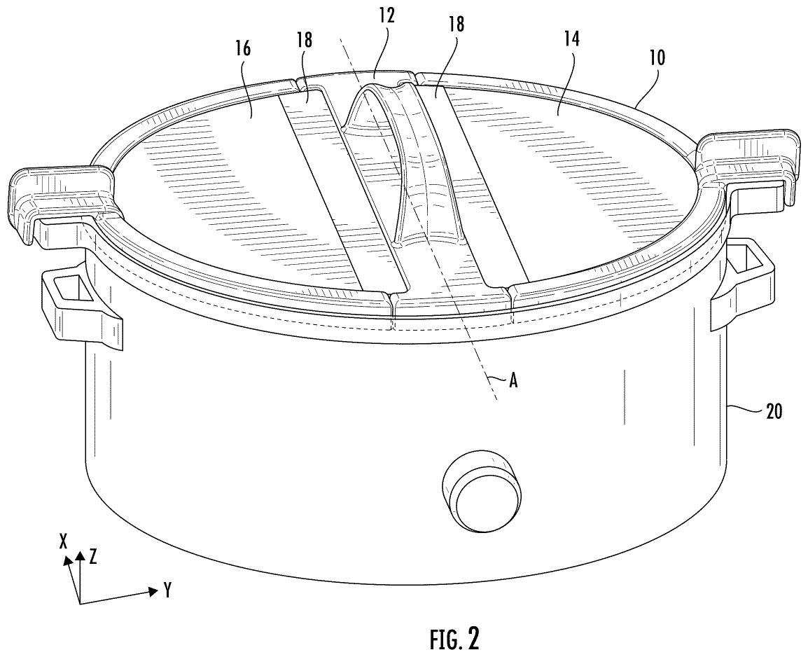

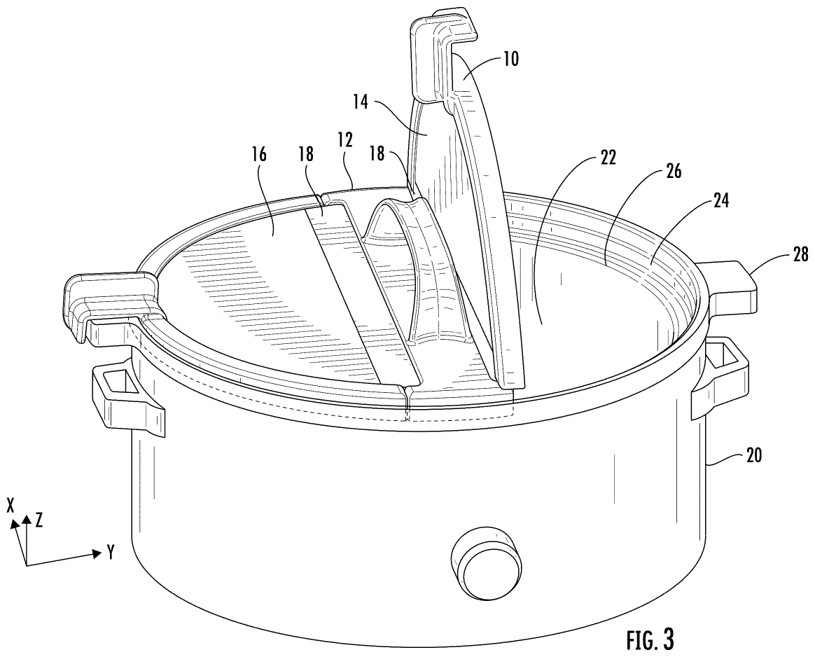

Referring to FIGS. 2 and 3, the kitchen appliance 20 may include a cavity 22 and an opening 26 of the cavity 22 may be bounded by a rim 24. The lid 10 may be positioned on the rim 24 of the kitchen appliance 20. In some embodiments, the rim 24 is circular or ovoidal and may have curved side edges. The rim 24 may be the uppermost surface of the kitchen appliance 20 in a first direction Z, however, the rim 24 may also be lower than the uppermost surface of the kitchen appliance 20. One edge of the rim 24 may curve down into the cavity 22 and the other side edge of the rim 24 may curve up toward the upper most surface of the kitchen appliance 20.

Referring now to FIGS. 1-3, the lid 10 may include a bridge 12 positioned between a first side section 14 and a second side section 16. The bridge 12 may be positioned to span any two points on the rim 24. In some embodiments, the rim 24 is substantially circular and the bridge 12 is positioned parallel to a diameter of the rim 24 and vertically above the same diameter in a first direction Z such that it spans between two points of the rim 24 which are directly opposite from one another; however, embodiments are not limited thereto. The bridge 12 may be positioned such that it spans two points on the rim 24 which are not directly opposite from one another.

In some embodiments, the rim 24 may be ovoidal. The bridge 12 may be positioned parallel to the minor axis of the rim 24 and centered vertically above the minor axis in a first direction Z. In some further embodiments, the bridge 12 may be positioned parallel to the major axis of the rim 24 and centered vertically above the major axis in a first direction Z.

Those of skill in this art will understand that, although the bridge 12 is shown herein being positioned parallel to or vertically above either the minor or major axis of the rim 24, other configurations are possible. For example, the bridge 12 may be positioned such that it spans two points on the rim 24 which are not directly opposite from one another.

In some embodiments, each of the first and second side sections 14, 16 may be substantially mirror images of each other about an axis A which represents a center line of the lid 10 in a second direction X. The first and second side sections 14, 16 may be shaped such that the lid 10 can provide full coverage of the cavity 22 of the kitchen appliance 20. For example, the first and second side sections 14, 16 may be substantially semi-circular or semi-ovoidal. The lid 10 may also include covers 18 either as parts of or attached to the side sections 14, 16 and pivotally connected to the bridge 12. In some embodiments, the covers 18 are connected to the first and second side sections 14, 16 such that they form a single component. Similarly, the lid 10 may be manufactured such that it forms a single component which may not be easily disassembled. The covers 18 may also provide coverage of the cavity 22 in conjunction with the bridge 12 and the first and second side sections 14, 16. In some embodiments, the bridge 12 is not positioned centered vertically above a diameter, minor axis, or major axis of the rim 24 and, therefore, the first and second side sections 14, 16 may not be substantially symmetrical to one another.

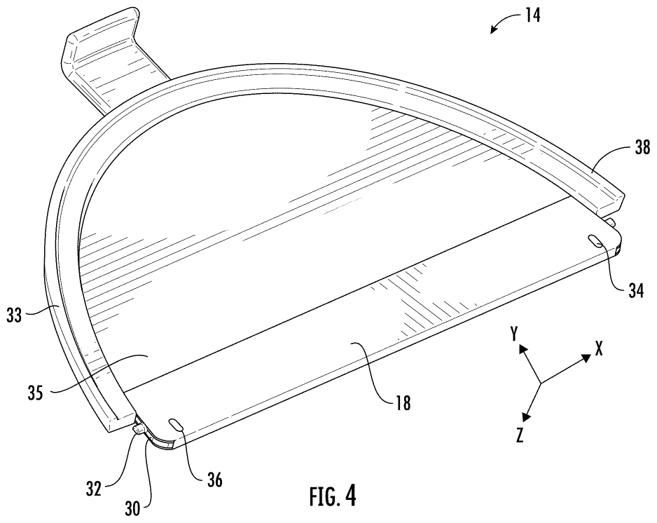

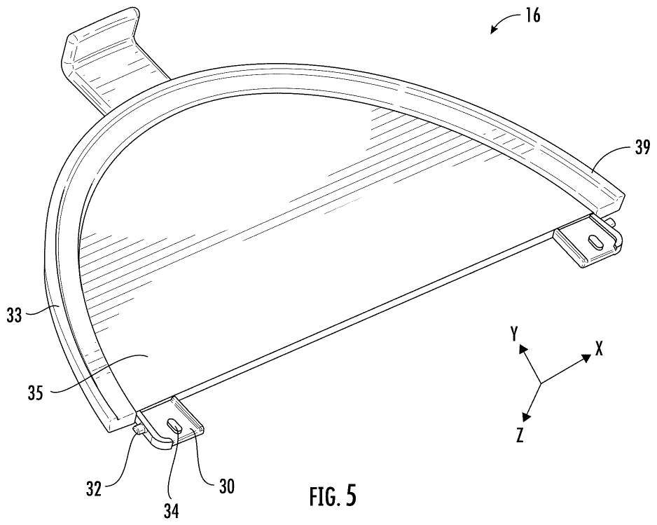

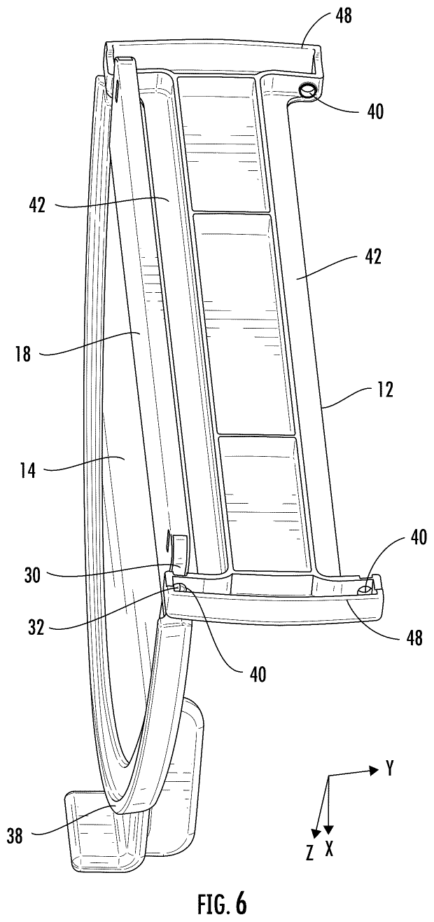

Referring now to FIGS. 3-6, each of the first and second side sections 14, 16 may be individually pivotally connected to the bridge 12, either directly or indirectly, such that the first and second side sections 14, 16 may be configured to move relative to the bridge 12. In some embodiments, the first and second side sections 14, 16 may include at least one flange 30 which protrudes in a third direction Y towards the bridge 12 when the lid is in the closed position 60. The flange 30 may have a pin 32 configured to mate with holes 40 in the bridge 12. In some embodiments, the first and second side sections 14, 16 each include two flanges 30 and the flanges 30 may each have a pin 32 configured to mate with holes 40 in the bridge 12. Together the pins 32 and holes 40 form hinged joints between the first and second side sections 14, 16 and the bridge 12. In other words, the pins 32 and holes 40 may be configured to pivotally connect the flanges 30 and bridge 12. The first and second side sections 14, 16 may be configured to utilize the hinged joint to rotate and thereby move relative to the bridge 12. In some further embodiments, the first and second side sections 14, 16 each include a single flange 30 with two pins 32 on opposite ends of the flanges 30 which mate with the holes 40 in the bridge 12 to form hinged joints between the first and second side sections 14, 16 and the bridge 12.

In some embodiments, the lid 10 further comprises covers 18 between the first and second side sections 14, 16 and the bridge 12. The covers 18 may be substantially ‘U’-shaped. In other words, the covers 18 may be comprised of two long flat plates which are separated by a small distance in a first direction Z and are in planes parallel to one another in a second and third directions X, Y with a third plate in a plane perpendicular to each of the first two plates and having edges which mate to the edges of the first two plates. In some embodiments, a first cover 18 is configured to mate with the first side section 14 and a second cover 18 is configured to mate with the second side section 16 such that for each of the first and second covers 18, the opening of the ‘U’ points towards the first or second side section 14, 16 respectively. In some embodiments, the covers 18 include openings 36 which are configured to mate with protrusions 34 on the flanges 30 of the first and second side sections 14, 16. The openings 36 and protrusions 34 may be configured to removably attach the covers 18 to the first and second side sections 14, 16. The covers 18 may be configured to at least partially cover the flanges 30 and/or the first and second side sections 14, 16.

In some embodiments, the bridge 12 further includes at least one stop feature 42 to prevent either one or both of the first and second side sections 14, 16 from rotating downwardly relative to the bridge 12. In some embodiments, the stop feature 42 interacts directly with a side section 14, 16. Alternatively, the stop feature 42 may interact directly with a flange 30 or a cover 18. In some embodiments, there may be two stop features 42, which may be flanges. One of the stop features 42 may be configured to extend outwardly from the bridge 12 towards the first side section 14 and the other stop feature 42 may be configured to extend outwardly from the bridge 12 towards the second side section 16. The stop features 42 may be configured such that their lower surfaces contact the upper surfaces of the covers 18 when the lid 10 is in the closed position 60. The stop features 42 may permit slight downward rotation of the first and second side sections 14, 16 or they may prevent any downward rotation of the first and second side sections 14, 16.

It will be appreciated by those skilled in the art that there are many possible designs in which the lid 10 and the kitchen appliance 20 may interface and the optimal design for an interface between the lid 10 and kitchen appliance 20 will vary depending on the intended use of the kitchen appliance 20. In some embodiments, lower surfaces 38, 39 of the first and second side sections 14, 16 respectively, and the lower surface 48 of the bridge 12 are configured to engage the rim 24 of the kitchen appliance 20. In some embodiments, the lower surfaces 38, 39, 48 are substantially planar with one another. The lower surfaces 38, 39 may be only a portion of a substantially planar bottom surface of each of the first and second side sections 14, 16, or they may be in a different plane or planes than other bottom surfaces of the first and second side sections 14, 16. Similarly, the lower surface 48 of the bridge 12 may be only a portion of a substantially planar bottom surface of the bridge 12, or it may be in a different plane or planes than other bottom surfaces of the bridge 12. Additionally, each of the lower surfaces 38, 39, 48 may not be a single contiguous surface, but may instead be multiple separate surfaces which may be substantially in a plane with one another. The lower surfaces 38, 39, 48 may also include a gasket, seal, or other such attachment (not shown) configured to mate with the rim 24 of the kitchen appliance 20 on one side and the lower surfaces 38, 39, 48 on the other.

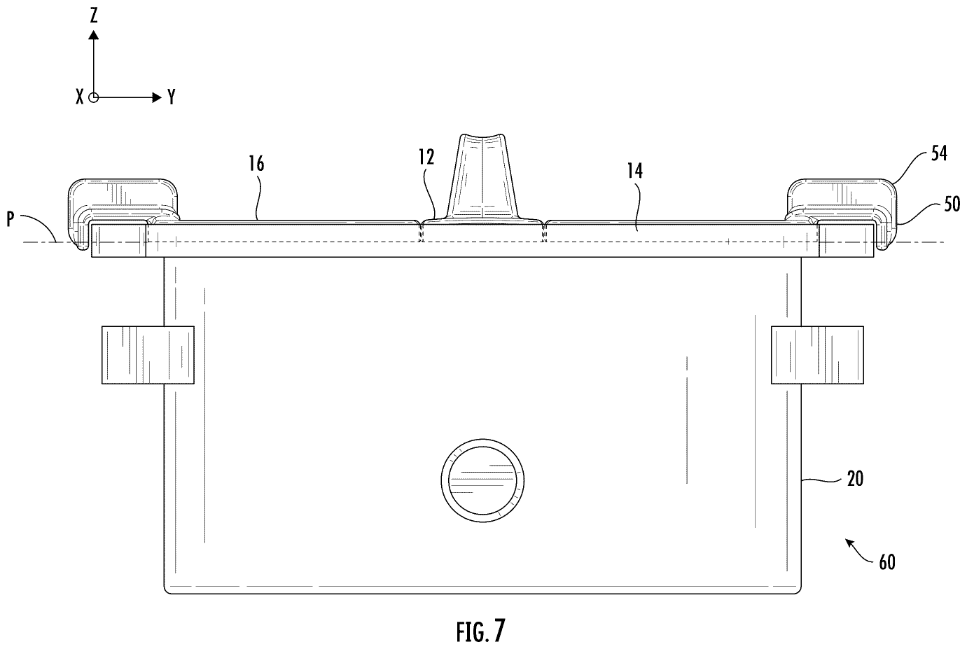

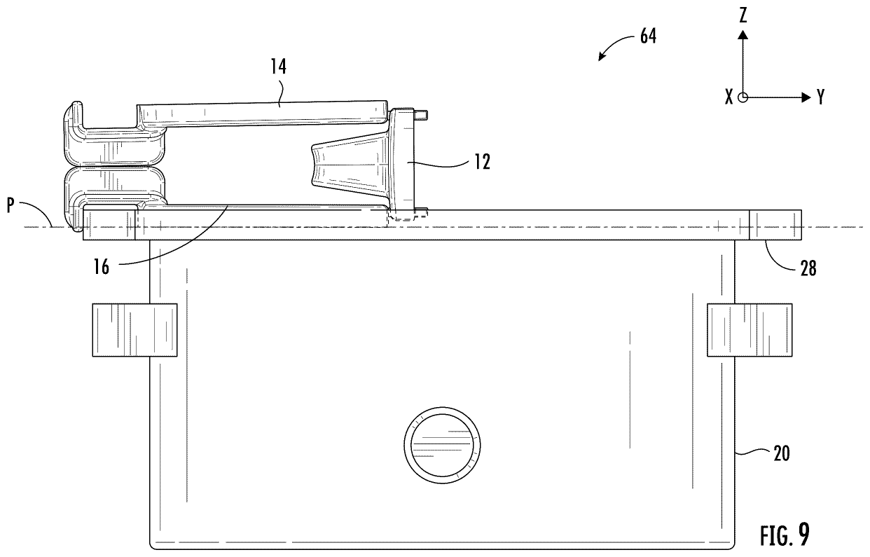

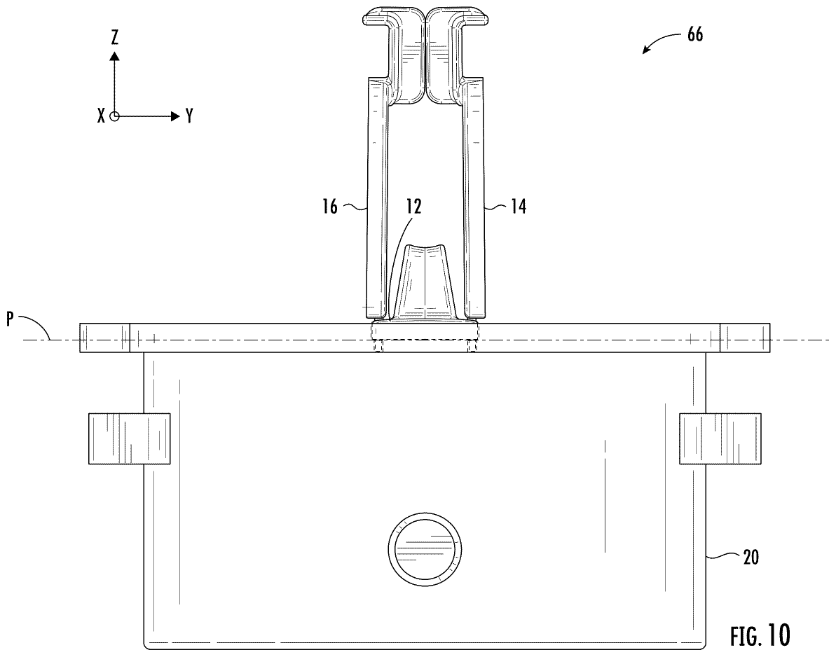

Referring now to FIGS. 7-10, while still engaged with the kitchen appliance 20, the lid 10 may be configured to be movable between multiple positions. In some embodiments, the lid 10 is configured to be moveable between four main positions: a closed position 60, a half-open position 62, a first fully-open position 64, and a second fully-open position 66.

In the closed position 60 (see FIG. 7), the lower surface 38 of the first side section 14, the lower surface 48 of the bridge 12, and the lower surface 39 of the second side section 16 are engaged with the rim 24 of the kitchen appliance 20 and the lid 10 covers substantially all of the opening 26 of the cavity 22 of the kitchen appliance 20. In other words, the lower surface 48 of the bridge 12, the lower surface 38 of the first side section 14, and the lower surface 39 of the second side section 16 are substantially planar and form a plane P. The plane P and a plane of the rim 24 of the kitchen appliance may be substantially the same plane. In some embodiments, in the closed position 60, the lid 10 fully engages the kitchen appliance 20 and the cavity 22 of the kitchen appliance 20 is, therefore, inaccessible.

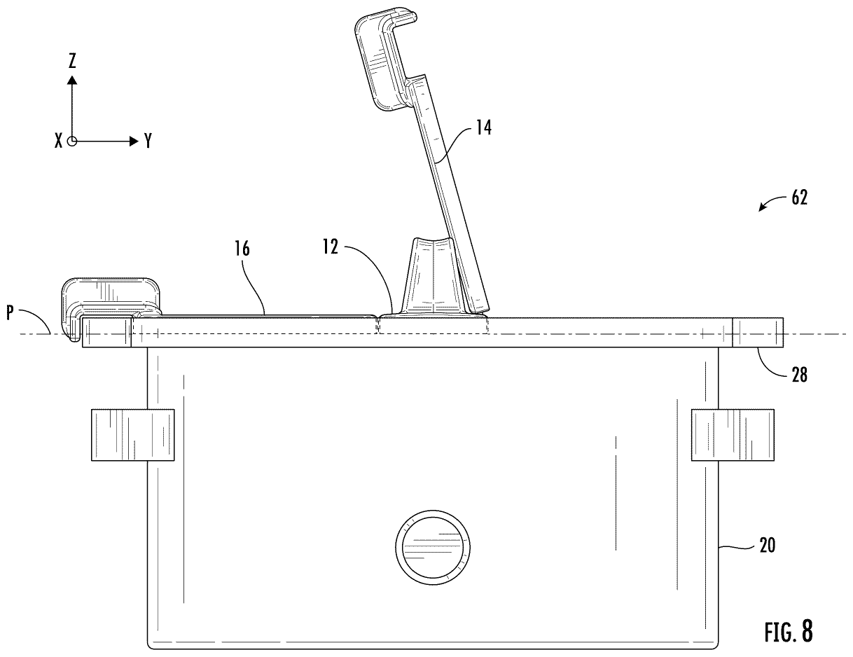

In the half-open position 62 (FIG. 8), the first side section 14 is generally perpendicular to a plane of the rim 24 of the kitchen appliance 20 and the lower surface 48 of the bridge 12 and the lower surface 39 of the second side section 16 are engaged with the rim 24 of the kitchen appliance 20. In other words, the lower surface 38 of first side section 14 may be generally perpendicular to the plane P formed by the lower surfaces 38, 39, 48 when the lid 10 is in the closed position 60. In some embodiments, the half-open position 62 may refer to a position of the lid 10 wherein slightly less than half of the opening 26 of the kitchen appliance 20 is uncovered and, therefore, the cavity 22 is partially accessible. While in the half-open position 62, the first side section 14 may be rotated more than 90 degrees from its closed position 60 orientation, however the embodiments are not limited thereto. In some embodiments, the first side section 14 may be rotated such that it engages a handle 44 of the bridge 12.

In the first fully-open position 64, the first side section 14 is at least partially directly above the second side section 16, the lower surface 39 of the second side section 16 is engaged with the rim 24 of the kitchen appliance 20, and the lower surface 48 of the bridge 12 is not engaged with the rim 24 of the kitchen appliance 20. In other words, the lower surface 38 of the first side section 14 is substantially parallel to the plane P formed by the lower surfaces 38, 39, 48 when the lid 10 is in the closed position 60 and the lower surface 48 of the bridge 12 is substantially perpendicular to the plane P formed by the lower surfaces 38, 39, 48 when the lid 10 is in the closed position 60. In some embodiments, the first-fully open position 64 may refer to a position of the lid 10 wherein slightly more than half of the opening 26 of the kitchen appliance 20 is uncovered and, therefore, the cavity 22 is mostly accessible. While in the first fully-open position, the bridge 12 may be rotated more than 90 degrees from its closed position orientation, however the embodiments are not limited thereto. In some embodiments, the bridge 12 may be rotated such that the handle 44 of the bridge 12 engages the second side section 16. Additionally, the first side section 14 may be rotated slightly more than 180 degrees from its closed position 60 orientation.

In the second fully-open position 66, both the first side section 14 and the second side section 16 are generally perpendicular to the plane of the rim 24 of the kitchen appliance 20 and the lower surface 48 of the bridge 12 is engaged with the rim 24 of the kitchen appliance 20. In other words, the lower surfaces 38, 39 of the first and second side sections 14, 16 are substantially perpendicular to the plane P formed by the lower surfaces 38, 39, 48 when the lid 10 is in the closed position 60. In some embodiments, the second-fully open position 66 may refer to a position of the lid 10 wherein the majority of the opening 26 of the kitchen appliance 20 is uncovered and, therefore, the cavity 22 is almost entirely accessible.

It will be appreciated by one of skill in the art that many additional features may be added to the lid 10. As an example, a handle 44 may be attached to the bridge 12. The handle 44 may take the form of a wide arch and may be substantially centered on the lid 10 with the width of the arch parallel to axis A or the center line of the lid 10 (as shown in FIG. 1). In some further embodiments, multiple handles may be added to the lid 10 and/or the handle 44 may be placed in another location or orientation on the lid 10 or may be omitted entirely.

The lid 10 may be made using a single material or it may include multiple different materials. Additionally, the bridge 12, first and second side sections 14, 16, and covers 18 may be made using a single material or they may include multiple different materials. For example, the lid 10, bridge 12, first and second side sections 14, 16, and covers 18 may be made from one of a polymer, plastic. metal, ceramic and/or silicone or a mixture thereof. In some embodiments, each of the first and second side sections 14, 16 may have an outer portion 33 and an inner portion 35. The outer portions 33 may be made of a different material than the inner portions 35. In some embodiments, the inner portions 35 may be made of a clear, “see-through”, and/or transparent material. The outer portions 33 may be silicone. In some embodiments, the bridge 12 may be plastic.

As illustrated in FIG. 7, the first and second side sections 14, 16 may each include at least one gripping feature 50. The gripping features 50 may be configured to engage a side surface or multiple side surfaces of the kitchen appliance 20. The gripping feature 50 of the first side section 14 may be configured to engage a first side surface of the kitchen appliance 20 and the second side section 16 may be configured to engage a second side surface of the kitchen appliance 20. In some embodiments, such as when the side surface of the kitchen appliance 20 is a cylinder, the first and second side surfaces of the kitchen appliance 20 may be different parts of the same side surface. In some further embodiments, the side surface or surfaces of the kitchen appliance 20 engaged by the gripping features 50 may be the side surfaces of upper handles 28. The upper handles 28 may be positioned above, below, on a plane with, or as a part of the rim 24 of the kitchen appliance 20. Furthermore, the gripping features 50 of the first and second side sections 14, 16 may be configured such that they engage an upper surface of the upper handles 28. In some embodiments, the gripping features 50 may provide additional weight to the areas of the lid 10 in which they are located. The additional weight may have the added benefit of increasing the frictional force between the lid 10 and the kitchen appliance 20. The additional weight may also produce a moment force within the lid 10 which may prevent the lid 10 from sliding into the kitchen appliance 20 when in the half-open position 62 or the first fully-open position 64.

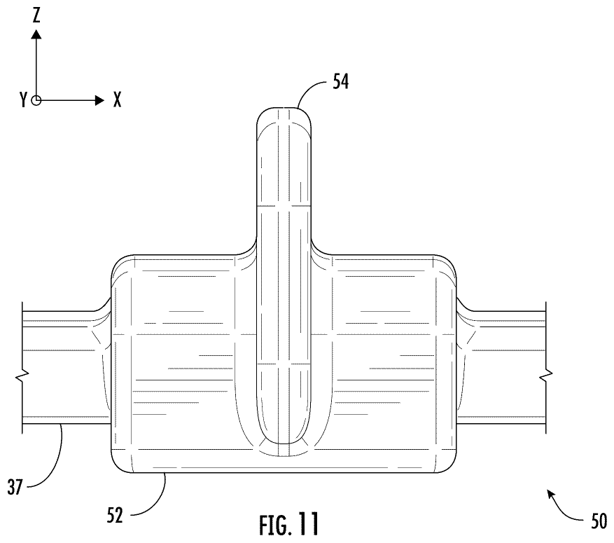

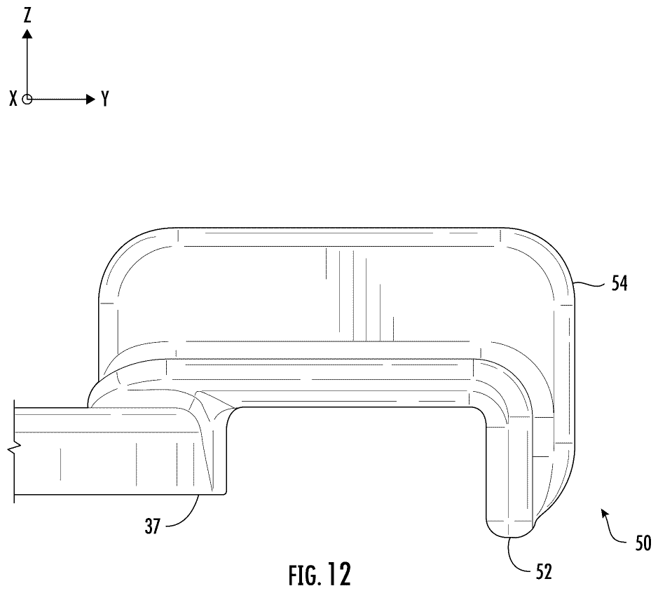

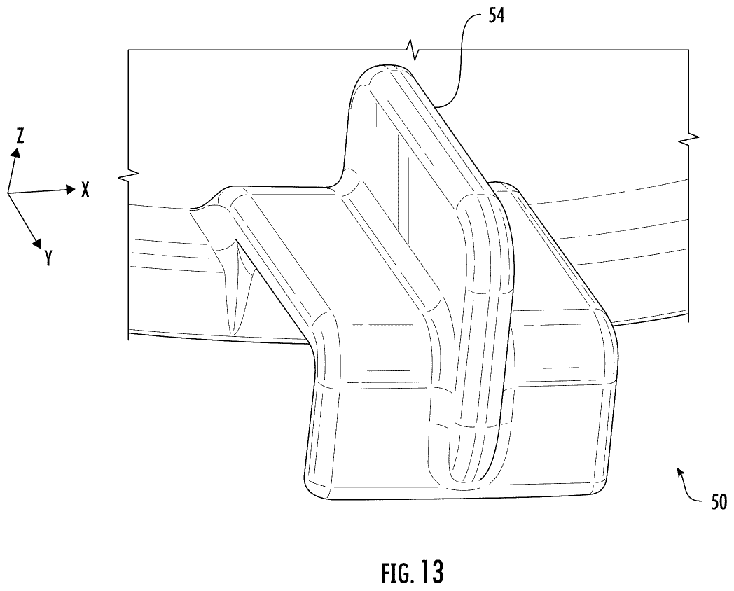

Referring now to FIGS. 11-13, the gripping features 50 may take any form capable of preventing or reducing movement of the lid 10 in the second and third directions X, Y relative to the kitchen appliance 20. In some embodiments, the gripping features 50 may be hooks or may be hook shaped. In the closed position 60, a lowest surface 52 of each of the gripping features 50 may be positioned further downwardly in the first direction Z relative to the lowest surfaces 37 of the remainder of the first and second side section 14, 16. This may permit the gripping feature 50 to reach downwardly in the first direction Z far enough to permit engagement with the side surface of the kitchen appliance 20.

In the closed position 60, half-open position 62, and first fully open position 64 the gripping features 50 may prevent the lid 10 from moving relative to the kitchen appliance 20. For example, the gripping features 50 may be hooks which are configured to engage a side surface or upper handle 28 of the kitchen appliance 20. In the closed position 60, the gripping features 50 of both of the first and second side sections 14, 16 may engage the kitchen appliance 20 and thereby physically prevent movement along at least one axis (for example the Y axis) through an interaction between the lowest surfaces 52 of the gripping features 50 and the upper handles 28 of the kitchen appliance 20. The gripping features 50 may similarly prevent movement along more than one axis. Similarly, when in the half-open or first fully-open positions 62, 64 a gripping feature 50 of either the first or second side section 14, 16 may be engaged with the kitchen appliance 20. A single gripping feature 50 may engage the kitchen appliance 20 such that it physically prevents movement along one or more axis through an interaction between the lowest surface 52 of the gripping feature 50 and the upper handles 28 of the kitchen appliance 20.

The gripping features 50 may also have a mass. The mass of the gripping features 50 may cause increased friction between the kitchen appliance 20 and the lid 10 (via the gripping features 50, the first side section 14, and/or the second side section 16). The increased friction may prevent the lid 10 from moving relative to the kitchen appliance 20 when the lid 10 is in any of the closed, half-open, first fully-open, or second fully-open positions 60, 62, 64, 66. The gripping features 50 may use a combination of physical interactions between the gripping features 50 and the kitchen appliance 20 as well as an increase in friction between kitchen appliance 20 and the lid 10 to prevent the lid 10 from moving along at least one axis. The gripping features 50 may prevent the lid 10 from moving relative to the kitchen appliance 20 in any manner other than moving between positions 60, 62, 64, 66 and/or lifting the lid 10 off of the kitchen appliance 20.

The first and second side sections 14, 16 may include vertical ridges or tabs 54 which may permit a user to more easily grip the lid 10 when moving the first or second side section 14, 16 between positions 60, 62, 64, 66. In some embodiments, the tabs 54 may be parts of or on the gripping features 50 and may add a significant amount of mass to the gripping features 50. The mass of the tabs 54 may increase the frictional force between the lid 10 and the kitchen appliance 20. The tabs 54 may extend vertically from the gripping features 50.

The foregoing is illustrative of the present invention and is not to be construed as limiting thereof. Although exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention.

That which is claimed is:

1. A kitchen appliance lid comprising:
a bridge;
a first side section pivotally connected relative to the bridge; and
a second side section pivotally connected relative to the bridge;
wherein the lid is moveable between:
(i) a closed position, wherein a lower surface of the first side section, a lower surface of the bridge, and a lower surface of the second side section are engaged with a rim of a kitchen appliance and the lid covers substantially all of an opening of a cavity of the kitchen appliance;
(ii) a half-open position, wherein the first side section is generally perpendicular to a plane of the rim of the kitchen appliance and wherein the lower surface of the bridge and the lower surface of the second side section are engaged with the rim of the kitchen appliance; and
(iii) a fully-open position, wherein the first side section is at least partially directly above the second side section, the lower surface of the second side section is engaged with the rim of the kitchen appliance, and the lower surface of the bridge is not engaged with the rim of the kitchen appliance.

2. The kitchen appliance lid of claim 1, wherein the fully-open position is a first fully-open position; and
the second side section is moveable between the closed position and a second fully-open position, wherein the first side section and the second side section are generally perpendicular to the plane of the rim of the kitchen appliance and wherein the lower surface of the bridge is engaged with the rim of the kitchen appliance.

3. The kitchen appliance lid of claim 1, wherein the first side section includes at least one flange pivotally connected relative to the bridge; and
wherein the second side section includes at least one flange pivotally connected relative to the bridge.

4. The kitchen appliance lid of claim 3, further comprising a first cover operatively connected to the at least one flange of the first side section; and
a second cover operatively connected to the at least one flange of the second side section.

5. The kitchen appliance lid of claim 1, further comprising a handle operatively connected to the bridge.

6. The kitchen appliance lid of claim 1, wherein the first side section includes a first gripping feature configured to engage a first side surface of the kitchen appliance and wherein the second side section includes a second gripping feature configured to engage a second side surface of the kitchen appliance.

7. The kitchen appliance lid of claim 6, wherein the first side surface of the kitchen appliance is a side surface of a first handle and wherein the second side surface of the kitchen appliance is a side surface of a second handle.

8. The kitchen appliance lid of claim 7, wherein the first gripping feature is configured to engage an upper surface of the first handle and wherein the second gripping feature is configured to engage an upper surface of the second handle.

9. The kitchen appliance lid of claim 6, wherein the first and second gripping features are hook shaped.

10. The kitchen appliance lid of claim 1, wherein the first side section further comprises an inner portion and an outer portion wherein the inner portion and the outer portion comprise different materials.

11. The kitchen appliance lid of claim 1, wherein the first side section and the second side section are substantially identical.

12. The kitchen appliance lid of claim 1, wherein the first side section is substantially semi-circular, and the second side section is substantially semi-circular.

13. The kitchen appliance lid of claim 1 wherein the first side section includes a vertical ridge on an outer portion of the first side section; and
the second side section includes a vertical ridge on an outer portion of the second side section.

14. A kitchen appliance comprising:
a main body;
a cavity, within the main body, having an opening;
a rim comprising a perimeter of the cavity; and
a lid configured to engage the rim of the kitchen appliance, the lid further comprising:
a bridge;
a first side section pivotally connected relative to the bridge; and
a second side section pivotally connected relative to the bridge;
wherein the first side section is moveable between:
(i) a closed position, wherein a lower surface of the first side section, a lower surface of the bridge, and a lower surface of the second side section are engaged with the rim of the kitchen appliance and the lid covers substantially all of the opening of the cavity of the kitchen appliance;
(ii) a half-open position, wherein the first side section is generally perpendicular to the second side section and wherein the lower surface of the bridge and the lower surface of the second side section are engaged with the rim of the kitchen appliance; and
(iii) a fully-open position, wherein the first side section is at least partially directly above the second side section, the lower surface of the second side section is engaged with the rim of the kitchen appliance, and the lower surface of the bridge is not engaged with the rim of the kitchen appliance.

15. The kitchen appliance of claim 14, wherein the first side section includes a first gripping feature configured to engage a first side surface of the kitchen appliance and wherein the second side section includes a second gripping feature configured to engage a second side surface of the kitchen appliance.

16. The kitchen appliance of claim 14, wherein the fully-open position is a first fully-open position; and
the second side section is moveable between the closed position and a second fully-open position, wherein the first side section and the second side section are generally perpendicular to the plane of the rim of the kitchen appliance and wherein the lower surface of the bridge is engaged with the rim of the kitchen appliance.

17. A kitchen appliance lid comprising:
a bridge;
a first side section pivotally connected relative to the bridge; and
a second side section pivotally connected relative to the bridge;
wherein the lid is moveable between:
(i) a closed position, wherein a lower surface of the bridge, a lower surface of the first side section, and a lower surface of the second side section are substantially planar and define a plane;
(ii) a half-open position, wherein the lower surface of first side section is generally perpendicular to the plane; and
(iii) a fully-open position, wherein the lower surface of the first side section is generally parallel to the plane and the lower surface of the bridge is generally perpendicular to the plane.

18. The kitchen appliance lid of claim 17, wherein the first side section includes a first gripping feature configured to engage a first side surface of the kitchen appliance and wherein the second side section includes a second gripping feature configured to engage a second side surface of the kitchen appliance.

19. The kitchen appliance lid of claim 17, wherein the fully-open position is a first fully-open position; and
the second side section is moveable between the closed position and a second fully-open position, wherein the first side section and the second side section are generally perpendicular to the plane of the rim of the kitchen appliance and wherein the lower surface of the bridge is engaged with the rim of the kitchen appliance.

20. The kitchen appliance lid of claim 17, wherein the first side section further comprises an inner portion and an outer portion wherein the inner portion and the outer portion comprise different materials.
